(19) United States
(12) Patent Application Publication
(10) Pub. No.: US 2015/0104627 A1
(43) Pub. Date: Apr. 16, 2015

(54) Multi-Layer Polymeric Films

(71) Applicant: The Procter & Gamble Company, Cincinnati, OH (US)

(72) Inventors: Hugh Joseph O'Donnell, Cincinnati, OH (US); Morgan Dean, Morrow, OH (US)

(73) Assignee: The Procter & Gamble Company, Cincinnati, OH (US)

(21) Appl. No.: 14/051,891

(22) Filed: Oct. 11, 2013

(51) Int. Cl. B32B 27/08; B32B 7/02; B32B 27/32

(52) U.S. Cl. CPC B32B 27/08; B32B 27/32; B32B 7/02; B32B 2250/04; B32B 2250/05; B32B 2250/242; B32B 2250/40; B32B 2250/42; B32B 2323/043; B32B 2323/10; B32B 2307/5825; B32B 2553/00; B32B 2307/54
USPC 428/216

(57) ABSTRACT

Multi-layer polymeric films and methods of forming the same are provided. The film includes a combination of layers forming the core of the film, and a polymeric skin layer forming each of the outer surfaces of the multi-layer film. The combination of layers forming the core of the film includes: a polypropylene-rich “A” layer, in which polypropylene is the major component of the “A” layer; and a polyethylene-rich “B” layer, in which polyethylene is the major component of the “B” layer. In some cases, the “B” layer may have high density polyethylene as its major component. In the core, there is at least one “A” layer and at least one “B” layer, and the “B” layer is joined at least indirectly to the “A” layer. The “A” layer(s) and the “B” layer(s) combine to make up 20% to 60% of the thickness of the multi-layer polymeric film.

### FIELD

The present disclosure generally relates to multi-layer polymeric films and methods of forming the same.

### BACKGROUND

Many products today require highly engineered components and yet, at the same time, these products are required to be limited use or disposable items. By limited use or disposable, it is meant that the product and/or component is used only a small number of times or possibly only once before being discarded. Examples of such products include, but are not limited to: personal care absorbent products such as diapers, training pants, incontinence garments, sanitary napkins, bandages, wipes and the like, and other disposable products such as trash bags and food bags, as well as products such as packaging materials. These types of products can and do utilize films. When films are used in limited use and/or disposable products, the impetus for maximizing engineered properties while reducing cost is extremely high.

In the area of films, there have been previous attempts to make films with improved properties. Such films, though not necessarily used for analogous purposes, are described in: U.S. Pat. No. 4,778,697; U.S. Pat. No. 5,071,686; U.S. Pat. No. 6,306,473 B1; U.S. Pat. No. 6,905,744 B1; U.S. Pat. No. 7,217,767 B2; U.S. Pat. No. 7,449,522 B2; U.S. Pat. No. 8,012,572 B2; U.S. Pat. No. 8,241,736 B2; U.S. Pat. No. 8,409,697 B2; U.S. Patent Application Publications US 2012/160728 A1 and US 2013/0143015 A1; EP 1 275 664 B1; and PCT Patent Publications WO 00/76765 A1; WO 2010/015402 A1; and WO 2012/085240.

However, the search continues for improved multi-layer polymeric films and methods for making the same. In particular, it would be desirable to have higher performance, lower cost multi-layer polymeric films. Higher performance includes providing multi-layer films with lower basis weights that are not brittle and do not tear easily. Therefore, it would be desirable to provide a multi-layer polymeric film which comprises lower basis weight, where the multi-layer polymeric film has improved performance characteristics to satisfy product and/or packaging needs.

### SUMMARY

The present disclosure generally relates to multi-layer polymeric films and methods of forming the same.

The multi-layer polymeric film has two outer surfaces and a thickness. The total thickness of the film is less than about 250 micrometers. In some cases, the total thickness of the film can be between about 5 micrometers and about 150 micrometers, alternatively between about 5 micrometers and about 50 micrometers. The film may comprise a combination of layers forming the core of the film, and a polymeric skin layer forming each of the outer surfaces of the multi-layer film. The combination of layers forming the core of the film comprises: a polypropylene-rich “A” layer, in which polypropylene is the sole or major component of the “A” layer; and a polyethylene-rich “B” layer, in which polyethylene is the sole or major component of the “B” layer. In some cases, the “B” layer may comprise high density polyethylene as its sole or major component. The “B” layer may be joined at least indirectly to the “A” layer. The “A” layer and the “B” layer may each have a thickness of greater than or equal to about 0.05 micrometers to less than or equal to about 15 micrometers. There is at least one “A” layer and at least one “B” layer. In addition, many embodiments are possible with more than one “A” and/or “B” layers. In such embodiments, the “A” and “B” layers can be in various arrangements including, but not limited to alternating and adjacent layer arrangements. The multi-layer polymeric film may further comprise other layers (for example, “C”, “D”, etc. layers) in addition to the “A” and “B” layers. In some cases, one or more of the additional layer(s) may serve as an energy dissipating layer (or “EDL”). The combination of layers forming the core of the film is at least indirectly joined to the skin layer(s).

A method of forming a multi-layer polymeric film is also provided. In one embodiment, the method may comprise: preparing a first composition; preparing a second composition; preparing a third composition; and co-extruding the first composition, second, and third compositions. The first composition comprises a polypropylene-rich composition, wherein polypropylene is the major or sole component of the first composition. If the first composition does not solely comprise polypropylene, polyethylene may comprise a second component of the first composition. The second composition comprises a polyethylene-rich composition comprising polyethylene as the major or sole component. In some cases, the second composition may comprise high density polyethylene as its sole or major component. The compositions may be formed into a layer arrangement in which the first and second compositions form layers of the core of the film, and the third composition forms a skin layer joined to the core of the film to form at least one of the outer surfaces of the multi-layer polymeric film.

### BRIEF DESCRIPTION OF THE DRAWINGS

FIG. 1 is a schematic representation of a multi-layer polymeric film having two skin layers and A and B layers that form the core of the film.

FIG. 2 is a schematic representation of a multi-layer polymeric film having two skin layers and a combination of A, B, and C layers that form the core of the film.

FIG. 3 is a schematic representation of a multi-layer polymeric film having two skin layers and one combination of A and B layers that form the core of the film.

FIG. 4 is a schematic representation of a multi-layer polymeric film having two skin layers and another combination of A and B layers that form the core of the film.

FIG. 5 is a schematic representation of a multi-layer polymeric film having two skin layers and another combination of A and B layers, along with energy dissipating layers that form the core of the film.

FIG. 6 is a schematic representation of a multi-layer polymeric film having two skin layers and another combination of A and B layers, along with energy dissipating layers that form the core of the film.

FIG. 7 is a schematic representation of a multi-layer polymeric film having two skin layers and several A/B repeating layers.

FIG. 8 is a schematic representation of a multi-layer polymeric film having two skin layers and several A/B/A repeating layers.

FIG. 9 is a schematic representation of a multi-layer polymeric film having two skin layers and several B/A/B repeating layers.

FIG. 10 is a schematic representation of a multi-layer polymeric film having two multi-layer stacks separated by a bulk layer.

FIG. 11 is a schematic diagram of the first state of sample preparation for web modulus measurement.

FIG. 12 is a schematic diagram of the second state of sample preparation for web modulus measurement.

FIG. 13 is a cross sectional view taken along the line 13-13 shown in FIG. 12.

FIG. 14 is a schematic diagram of the third state of sample preparation for web modulus measurement.

FIG. 15 is a cross sectional view taken along the line 15-15 shown in FIG. 14.

FIG. 16 is a schematic diagram of the fourth state of sample preparation for web modulus measurement.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the absence of particular elements in any of the exemplary embodiments, except as may be explicitly delineated in the corresponding written description. The drawings are not necessarily to scale.

### DETAILED DESCRIPTION

### I. Definitions

As used herein, the following terms shall have the meaning specified thereafter:

“Bio-based content” refers to the amount of carbon from a renewable resource in a material as a percent of the mass of the total organic carbon in the material, as determined by ASTM D6866-10, method B.

“Bulk layer” refers to a layer of the multi-layer film that adds bulk to the film by having a thickness greater than 1 micrometers, and that lies between the skin layers, and is not part of the “A” and “B” layers.

“Copolymer” refers to a polymer derived from two or more polymerizable monomers. When used in generic terms, the term “copolymer” is also inclusive of more than two distinct monomers, for example, ter-polymers. The term “copolymer” is also inclusive of random copolymers, block copolymers, and graft copolymers.

As used herein, the term “polymer” is inclusive of homo-polymers and copolymers, and copolymers can exhibit both homogeneous and heterogeneous morphologies.

Copolypropylene (“coPP”) refers to a copolymerization of propylene and another monomer such as ethylene or an alpha-olefin exemplified by a propylene-ethylene block, or random copolymer.

“Core” refers to the inner layers of the multi-layer film (between the skin layers) and can include multi-layer or microlayer repeating stacks and/or bulk layers. The term “core” does not require that such inner layers be centered inside the film.

“Energy dissipating layer” or “EDL” refers to a layer that can be used to improve at least one of: the dart impact resistance of the film as measured by ASTM D1709-09, or the total energy impact by dart drop as measured by ASTM D4272-09, in comparison to a film having the same structure but without an EDL.

“Homo-polymer” refers to a polymer derived from a single polymerizable monomer.

“Impact copolymer propylene” or “impact copolypropylene” (or “ICP”) refers to a type of copolypropylene (“coPP”) in which a copolymer is formed inside the pores of a homo-polymer, and may, thus, be considered to be heterophasic.

“Joined to” encompasses configurations in which an element is directly secured to another element by affixing the element directly to the other element, and configurations in which the element is indirectly secured to the other element by affixing the element to intermediate member(s) which in turn are affixed to the other element. “Affixed” includes, but is not limited to structures in which elements are held together by having been coextruded.

“Major component” refers to greater than 50 wt. % of the specified resin within the specified layer or composition.

“Micro-layer” refers to a layer having a thickness of less than one micron (micrometer).

“Olefin block copolymer” or “OBC” is a multi-block copolymer and may include ethylene and one or more copolymerizable α-olefin comonomer in polymerized form. The blocks are characterized by different alpha-olefin chemical composition or alpha-olefin comonomer distribution within the block versus adjacent regions in the molecule.

“Polyethylene-rich” refers to a layer in which polyethylene is the major component of the layer.

“Polyolefin” refers to any polymerized olefin, which can be linear, branched, cyclic, aliphatic, aromatic, substituted, or unsubstituted, including “modified polyolefin” and copolymers. More specifically, included in the term polyolefin are homo-polymers of olefin, copolymers of olefins, copolymers of an olefin and a non-olefinic co-monomer copolymerizable with the olefin, such as vinyl monomers, modified polymers thereof, and the like. The polyolefins need not be limited to polymers of ethylene but could be any homopolymer or copolymer known in the art such as, ethylene with alpha-olefin, polypropylene, polypropylene with alpha-olefin such as propylene-butene copolymer, poly(butene-1), ethylene vinyl acetate resin, poly(4-methyl-1-pentene), ethylene acrylic acid, ethylene based ionomers, any low density polyethylene, and the like.

“Polypropylene-rich” refers to a layer in which polypropylene is the major component of the layer.

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

The terms “standard conditions” or “standard temperature”, as used herein, refer to a temperature of 77° F. (25° C.) and 50% relative humidity.

All proportions described herein are by weight, unless otherwise specified.

### II. Films

Multi-layer films and methods of making the same are disclosed. The film comprises a combination of layers forming the core of the film, and a polymeric skin layer forming at least one, and typically each of the outer surfaces of the multi-layer film. The combination of layers forming the core of the film comprises at least one layer designated herein as an “A” layer and at least one layer designated as a “B” layer, wherein the “A” and “B” layers have a different composition. In addition, many embodiments are possible with more than one “A” and/or “B” layers. In such embodiments, the “A” and “B” layers can be in various arrangements including, but not limited to alternating and adjacent layer arrangements. The “A” and “B” layers can serve any suitable purpose including but not limited to providing stiffness, strength, and/or reinforcement to the film.

FIG. 1 shows one multi-layer film 20 that comprises two skin or “S” layers and a combination of an “A” layer and a “B” layer forming the core 22 therebetween. Each skin layer forms one of the outer surfaces of the multi-layer film 20. Each of the layers described herein has two opposed surfaces. The surfaces may be referred to herein as a first (or “upper”) surface and a second (or “lower”) surface. It is understood, however, that the terms “upper” and “lower” refer to the orientation of the multi-layer film shown in the drawings for convenience, and that if the film is rotated, these layers will still bear the same relationship to each other, but an upper layer may be a lower layer and a lower layer may be an upper layer after the film is rotated. The layers are arranged so at least one surface of a layer is joined to the surface of another layer.

The “A” layer(s) of the multi-layer polymeric film comprises a polypropylene-rich layer, in which polypropylene is the major component or sole component of the layer. If the “A” layer does not solely comprise polypropylene, the “A” layer may comprise polyethylene as an optional additional component. Any suitable type of polypropylene that provides strength, stiffness, and/or reinforcement to the film and any polyethylene that provides ductility to the polypropylene can be used in the “A” layer. These components can be blended in any suitable proportions, provided that polypropylene is the major component of the layer. Some types and proportions of polypropylene, however, may provide the film with more desirable properties.

Suitable types of polypropylene (PP) include, but are not limited to: homopolymer isotatic PP and copolymer propylene (coPP). Copolymer propylene (coPP) includes random and block polymers that include ethylene and other alpha-olefin comonomers to form copolymers such as propylene-ethylene block copolymers, propylene-ethylene random copolymers, heterophasic copolypropylene including impact copolypropylene (or “ICP”), as well as any blend thereof. The materials in the “A” layers (and “B” layers described below) may be chosen to have higher tensile strength and modulus than that of the materials in the skin or any bulk layers described below. One suitable polypropylene is impact copolymer polypropylene. An example of commercial impact copolymer polypropylene resin is PRO-FAX® 7624 available from LyondellBasell (or “LBI”) of Houston, Tex., U.S.A.

Suitable types of polyethylenes (PE) include, but are not limited to: linear low density polyethylene (LLDPE), low density polyethylene (LDPE), medium density polyethylene (MDPE), ethylene vinyl acetate, and ethylene copolymers such as random or multi-block ethylene alpha-olefin. The particular polyethylene may be selected to improve the ductility of the “A” layer. The polyethylenes can be polymerized using any suitable reaction system such as high pressure, slurry, gas phase, and any suitable catalyst system such as Ziegler Natta, constrained geometry, or single-site/metallocene. An example of a suitable commercial polyethylene resin is DOWLEX® 2045G available from the Dow Chemical Company of Midland, Mich., U.S.A. In some cases, it may be desirable for the “A” layer to be substantially, or completely free of high density polyethylene (HDPE). Without wishing to be bound by any particular theory, it is believed that placing the polypropylene and HDPE in separate layers may improve the mechanical properties of the multi-layer film.

The “A” layer may also comprise other suitable materials including, but not limited to ethylene alpha-olefins, including, but not limited to polyolefin plastomers (POP), polyolefin elastomers (POE), olefinic block copolymers (OBC's), and additives. Polyolefin plastomers and polyolefin elastomers are typically thermoplastic. Example commercial polyolefin plastomer resins include Dow AFFINITY™ 1850G available from the Dow Chemical Company, and ExxonMobil EXACT™ 4056 available from the ExxonMobil Chemical Company, Houston, Tex., U.S.A. Example commercial polyolefin elastomers include ENGAGE™ 8450 available from the Dow Chemical Company. Example olefinic block copolymer elastomers include INFUSE™ 9100 available from the Dow Chemical Company.

Suitable proportions of polypropylene in the “A” layer(s) include, but are not limited to: greater than 50%, alternatively greater than or equal to about 60 wt. % to about 100 wt. % of polypropylene, alternatively between about 70 and about 100 wt. %, alternatively between about 75 and about 95 wt. %. The total amount of all types of polymers used in the “A” layers may comprise any suitable weight percentage of the “A” layers, such as from greater than 50% to about 100%, alternatively from about 70% to about 100%, alternatively from about 75% to about 95% by weight of each of the “A” layers.

In certain cases, at least some of the polypropylene in the “A” layer(s) comprises at least one of a homo-polymer PP or coPP. In some films, coPP may be the major component of the “A” layer(s). The coPP may, thus, comprise greater than 50%, alternatively greater than or equal to about 60 wt. % to about 100 wt. % of coPP, alternatively between about 70 and about 100 wt. %, alternatively between about 75 and about 95 wt. % of the “A” layer(s). The “A” layer(s) may comprise coPP having a largest enthalpic melting point peak greater than 140° C., alternatively greater than or equal to 150° C. The largest enthalpic melting point peak, reported as heat flow, is measured using differential scanning calorimeter at a scan rate of 10° C./min. The sample is heated, cooled, and heated a second time to erase previous thermo mechanical history. The DSC melting point, Tₚₘ, from the second heat cycle is used for this determination as defined in ASTM D3418. The coPP may have a melt flow rate from about 0.5 to about 10. In some films, the “A” layer(s) may comprise a blend of impact or heterophasic coPP and at least one of the following: LDPE, LLDPE, polyolefin plastomer (POP), or polyolefin elastomer (POE), or OBC.

The “A” layer(s) may have any suitable properties. In some of the multi-layer films, the overall or average density of the composition used to form the “A” layer is from about 0.87 g/cm³ to about 0.91 g/cm³.

The “A” layer(s) may each have any suitable thickness including, but not limited to a thickness of less than or equal to about 15 micrometers. Alternatively, the “A” layer(s) may each have a thickness that is greater than or equal to about any of the following: 0.05, 0.1, 0.2, or 0.4 micrometers to less than or equal to about any of the following: 15, 10, 5, or 1 micrometers. Thus, the “A” layer(s) may have a range of thickness between about 0.05 micrometers and about 15 micrometers including, but not limited to: between about 0.2 micrometers and about 15 micrometers; alternatively between about 0.4 micrometers and about 10 micrometers. The thickness of the “A” layer, if only one, or the thickness of all of the “A” layers combined (if more than one) may range from about 10% to about 30% of the total thickness of the multi-layer film, or alternatively from about 15% to about 25% of the multi-layer film.

The “B” layer(s) of the multi-layer polymeric film comprises polyethylene (PE) as the major component. In certain cases, it may be desirable for the polyethylene in the “B” layer(s) to comprise high density polyethylene (HDPE) as the major component. When the “B” layer comprises HDPE, the density of the HDPE used in the “B” layer(s) may be greater about 0.94 g/cc, alternatively greater than about 0.95 g/cc, alternatively greater than or equal to about 0.955 g/cc. The maximum density of the HDPE used in the “B” layer(s) may be less than or equal to about 0.97 g/cc, alternatively less than or equal to about 0.965 g/cc.

The “B” layer(s) can comprise any other suitable material in addition to polyethylene (or HDPE) including, but not limited to: ethylene alpha-olefins, which include, but are not limited to polyolefin plastomers, polyolefin elastomers, OBC's; and additives. Specific examples of such other suitable materials include, but are not limited to: LDPE, LLDPE, ethylene vinyl acetate, and ethylene methyl acrylate. In certain embodiments, the “B” layer(s) may comprise a blend of HDPE and at least one of LDPE and LLDPE. The total amount of all types of polymers used in the “B” layers may comprise any suitable weight percentage of the “B” layers, such as from greater than 50% to about 100%, alternatively from about 70% to about 100%, alternatively from about 75% to about 95% by weight of each of the “B” layers. Some types and proportions of polyethylene, however, may provide the film with more desirable properties.

The polyethylene (for example, HDPE) can comprise any suitable proportion of the “B” layer(s) including, but not limited to: greater than 50 wt. %, alternatively greater than or equal to about 60 wt. % to 100 wt. %, alternatively between about 70 and about 100 wt. %, alternatively between about 80 and about 100 wt. %, and alternatively between about 75 and about 95 wt. %.

The “B” layer may have any suitable properties. In certain embodiments where resin includes only PE or ethylene-alpha-olefin, the overall or average density of the composition making up the “B” layer may be greater than or equal to about 0.93 g/cm³, alternatively greater than or equal to about 0.94 g/cm³, or alternatively greater than or equal to about 0.95 g/cm³.

The “B” layer(s) may have a thickness in the same ranges specified herein for the “A” layers. The thicknesses of each of the “B” layers may, thus, be between about 0.05 micrometers and about 15 micrometers. The thickness of the “B” layer, if only one, or the thickness of all of the “B” layers combined (if more than one) may range from about 10% to about 30% of the total thickness of the multi-layer film, or alternatively from about 15% to about 25% of the multi-layer film.

The “A” layer(s) and the “B” layer(s) can have substantially the same thickness, or different thicknesses. In addition, it is not necessary for all of the “A” layers to have the same thickness as other “A” layers, or all of the “B” layers to have the same thickness as other “B” layers. It is also not necessary for all of the “A” and “B” layers to have the same thickness relative to each other. Thus, some “A” layers may have the same thickness as some “B” layers, and some “A” layers may have a different thickness than some “B” layers. This may be a function of the method of making the film, and will be further described below. In some embodiments, the thickness of the A and/or B layers may increase or diminish throughout the thickness of the film yielding a gradient layering structure. The ratio of the thickness of an “A” layer to a “B” layer can be in any suitable range including, but not limited to from about 1:1 to about 1:5 or 5:1 to 1:1; alternatively from about 1:1.1 to about 1:4 or 4:1 to 1.1:1.

At least some of the “A” layers and/or “B” layers can be “macrolayers”, having a thickness of greater than or equal to 1 micrometer. If the “A” and “B” layers are all macrolayers, the entire film can be a macrolayer film. Alternatively, at least some of the “A” layers and/or “B” layers can be “microlayers”, having a thickness of less than 1 micrometer. For example, microlayer “A” and “B” layers can have a thickness of greater than or equal to about 0.05 micrometers to less than or equal to about: 0.9, 0.8, 0.75, 0.7, 0.6, 0.5, or 0.4 micrometers.

Regardless of whether the “A” layers and “B” layers are macrolayers or microlayers, the sum of the thickness of all of the “A” and “B” layers may be less than or equal to about 60% of the total thickness of the multi-layer film, alternatively less than or equal to about 50% of the film. The sum of the thickness of all of the “A” and “B” layers may, for example, range from about 20% to about 50%, alternatively from about 20% to about 40% of the film thickness.

The relative weight fraction of the layers is a measure of the relative weights of the compositions that are used to form the respective layers. The relative weight fraction between the “A” layer(s) and the “B” layer(s) (i.e., the sum of the weight fraction of all the “A” or “B” layers, in case more than one layer “A” or “B” is present) may be between about 1:5 and 5:1; alternatively between about 1:3 and 3:1; alternatively between about 1:2 and 2:1; and alternatively between about 1:1.5 and 1.5:1.

Additional layers may be included in the multi-layer polymeric film which are neither “A” layers nor “B” layers (e.g., one or more “C”, “D”, etc. layers). The other layer(s) may be included for any suitable purpose, including to further modify the film properties, and/or to add bulk for mechanical strength to the film. The other layer(s) may be comprised of any suitable materials. Suitable materials include polymeric or polyolefin resins, including, but not limited to: polyolefin plastomers and elastomers, OBC, ethylene vinyl acetate, and/or bio-derived polyolefin resins. The additional layers can be microlayers having a thickness less than 1 micrometer that are part of a microlayer stack; or bulk layers having a thickness greater than or equal to 1 micrometer that are not part of a microlayer stack.

In some cases, the additional layer(s), for example, the “C” layer(s) may comprise a polyolefin plastomer, polyolefin elastomer, or OBC. Such a layer may serve as an energy dissipating layer (EDL) (or impact layer). In certain embodiments, the EDL in a multilayer film may be located adjacent to and/or between the polypropylene-rich “A” layer and the polyethylene-rich “B” layer. In some cases, it may be desirable for any EDL to be distinguishable from tie layers that serve primarily to join two (incompatible) layers together. Thus, the energy dissipating layer (EDL) and layers adjacent thereto may be sufficiently similar in properties that there is no delamination therebetween. When present, the EDL, if only one, or the thickness of all of the EDL's combined (if more than one) may be less than or equal to about 15% of the film thickness, alternatively less than or equal to about 10% of the film thickness.

In some embodiments, the additional layer(s) may comprise bulk layers which may be designated in the drawings as “Bulk” or by reference number 24. The bulk layer(s) may comprise any suitable materials. Suitable materials for the bulk layer(s) include any of those materials described above for the additional layers. In certain embodiments, the bulk layer(s) may comprise a blend of LDPE and LLDPE. In other embodiments, the bulk layers may comprise, or in some cases, may consist essentially of, one or more of the following: polyolefin plastomers, polyolefin elastomers, OBC, ethylene vinyl acetate, and/or bio-derived polyolefin resins. The properties of any bulk layers are further described below in conjunction with the skin layers.

The skin layer(s), S, can serve any suitable function. Such functions may include, but are not limited to controlling the properties of the multi-layer film 20 so that the multi-layer film has the desired overall properties (e.g., mechanical properties, bulk, softness, etc.). The skin layer(s) may also serve to provide stability during extrusion, and/or provide the multi-layer film with still other properties, such as: better receptivity to printing; and better bonding or sealing to itself and/or to other materials.

The skin layer(s) may comprise any materials suitable for such purposes. Suitable materials for the skin layer(s) include, but are not limited to: polymeric or polyolefin resins; bio-derived polyolefin resins; ethylene vinyl acetate; ethylene acrylic acid; and DuPont™ SURLYN® (ethylene methacrylic acid (E/MAA) copolymers in which part of the methacrylic acid is neutralized with metal ions such as zinc (Zn) or sodium (Na)); and additives. In some embodiments, the skin layer(s) comprise a blend of LDPE and LLDPE. For packaging applications having a seal, the skin layer(s) may comprise a high proportion of metallocene-based LLDPE including, but not limited to, greater than or equal to about 50%, alternatively about 75% metallocene-based LLDPE. In certain cases, it may be desirable for the skin layers to be substantially or completely free of polypropylene in order for the outside of the film to be less rough (softer to the touch), less stiff, and less noisy.

Although a single skin layer S is possible, there will typically be a skin layer S on each side of the multi-layer film. The skin layer on one side of the multi-layer film can comprise the same materials as the skin layer on the other side of the multi-layer film. In other embodiments, the skin layers can differ in composition.

The skin layers S and any bulk layer(s) can be of any suitable thickness. Each of the skin layers can have the same thickness, or the two skin layers may differ in thickness. The bulk layer(s) may have the same thickness as either of the skin layers, or a different thickness. For example, each bulk layer may have a thickness of less than or equal to, or less than 10% of the film thickness. If there is more than one bulk layer, the bulk layers can have the same thickness, or the bulk layers may differ in thickness. The skin layer(s) and any bulk layer(s) may comprise any suitable portion of the total thickness of the multi-layer film. The skin layer(s) and any bulk layer(s) may have a total thickness (that is, combined thickness) that is at least about 40% of the film, alternatively from about 40% to about 80%, alternatively from about 40% to about 70%, or alternatively from about 40% to about 60% of the thickness of the multi-layer polymeric film. The sum of the thickness of the skin layer and any bulk and/or any energy dissipating layer (EDL) may range from about 40% to about 80% of the film thickness.

The skin layers S and bulk layer(s) (if present) can have any suitable average density. For example, if the skin layers S and bulk layer comprise ethylene or ethylene alpha-olefin, suitable ranges of average density of the composition(s) comprising the skin layers S and bulk layer(s) include, but are not limited to between about 0.90 g/cm³ and 0.93 g/cm³. In some embodiments, the skin layers may comprise a composition having an average density of about 0.92 g/cm³.

When selecting polymers for the respective layers of the multi-layer polymeric film, such layers can be compatible and self-adhering to each other. This prevents problems from occurring in joining the two or more layers (such as by coextrusion) into a substantially continuous, unitary multi-layer polymeric film. The multi-layer polymeric film may, thus, be free of adhesive or tie layers joining the layers together. Of course, in other embodiments, adhesive or tie layers could be used. The core may be joined to the skin layers by having an “A” layer, a “B” layer, or an additional layer attached to either of the skin layers.

In some embodiments, during manufacture of the multi-layer films, one of the streams used to form the layers (such as an “A” layer) may be split into two separate streams. In such a case, the layers (for example, “A” layers) formed by the split stream (which may be designated A′ and A″) may have significantly less thickness than the other “A” layer(s) (and “B” layer(s)). In one embodiment, an A layer is split into two parts and forms the outside of the core of the film so that the skin layer is attached to an A′ and/or A″ layer(s) (where the outer A′ and A″ layers are approximately one-half the thickness of other “A” layers). Such split layers may, but need not be equal in thickness. In other embodiments, the B layer may be split into two parts and each part forms the outside of the core of the film.

Any of the materials in the various layers (“A”, “B”, “C”, etc., skin layers, bulk layers) of the multi-layer film 20 can comprise: pre-consumer recycled materials (materials recycled during manufacture); post consumer recycled materials (materials recycled after use by consumers); materials that provide the film with a bio-based content (such as in addition to, or in place of petroleum-derived polyolefins); and combinations or blends of any of these types of materials. Materials that provide the film with a bio-based content include materials that are at least partially derived from a renewable resource. Such materials include polymers that are derived from a renewable resource indirectly through one or more intermediate compounds.

Particularly desirable intermediates include olefins. Olefins such as ethylene and propylene may be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Other sources of materials to form polymers include post-consumer recycled materials. Sources of post-consumer recycled materials can include plastic bottles, e.g., soda bottles, plastic films, plastic packaging materials, plastic bags and other similar materials which contain synthetic materials which can be recovered.

Such materials that may provide the film with a bio-based content, and post-consumer recycled materials are described in The Procter & Gamble Company's U.S. Patent Application Publication No. US 2012/0263924 A1.

The multi-layer polymeric films may comprise additional materials for any purpose (e.g., additives) in any layer of the film. Additional materials may comprise other polymers (e.g., polypropylene, polyethylene, ethylene vinyl acetate, polymethylpentene, cyclic olefin copolymers, polyethylene ionomers, any combination thereof, or the like), opacifying materials, minerals, processing aids, extenders, waxes, plasticizers, adhesive layers, anti-blocking agents, anti-oxidants, fillers (e.g., glass, talc, calcium carbonate, or the like), nucleation agents, mold release agents, flame retardants, electrically conductive agents, anti-static agents, pigments, impact modifiers, stabilizers (e.g., a UV absorber), wetting agents, dyes, or any combination thereof. Minerals can include without limitation calcium carbonate, magnesium carbonate, silica, aluminum oxide, zinc oxide, calcium sulfate, barium sulfate, sodium silicate, aluminum silicate, mica, clay, talc, titanium dioxide, halloysite, and combinations thereof.

The multi-layer film may comprise numerous different layer arrangements, a non-limiting number of which are shown in the drawings. The multi-layer film comprises at least one “A” layer and at least one “B” layer, and typically further comprises a polymeric skin layer that forms each of the outer surfaces of the multi-layer film. The “A” layer(s) and the “B” layer(s) can be provided in the form of a single A/B unit as shown in FIG. 1, where A is the polypropylene-rich layer and B is the polyethylene-rich (e.g., HDPE) layer.

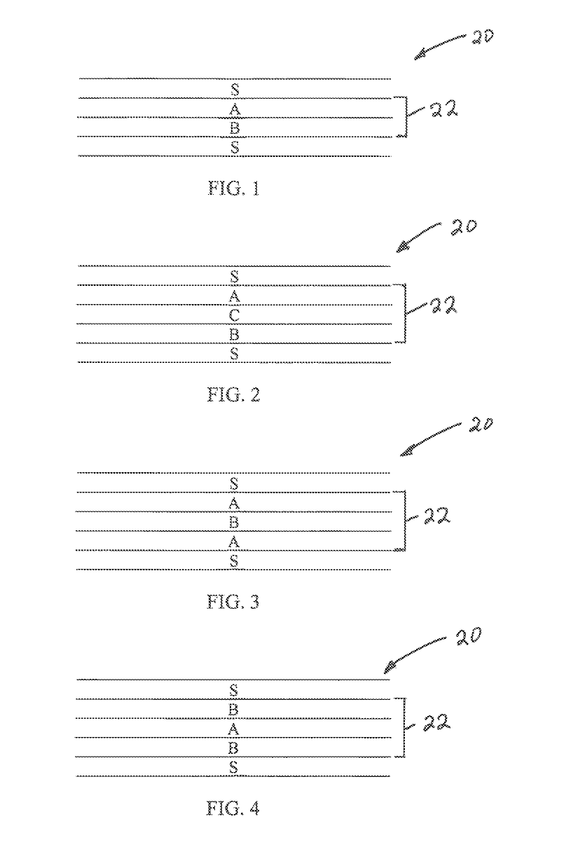

In other embodiments, as shown in FIG. 2, additional layers or microlayers may be included in the multi-layer polymeric film which are neither “A” layers nor “B” layers (e.g., one or more “C”, “D”, etc. layers). As noted above, such additional layer or layers can be an energy dissipating layer (EDL), or other type of layer. Such additional layers or microlayers can be internal layers of the sequence, being interposed between the A, and/or B layers (for example, A/C/B), and/or they may be positioned on one or both sides of the indicated sequences, that is, on the outer surfaces of the A and/or B layers. The C, D, etc. layers may provide other properties desired of the films described above including, but not limited to impact resistance.

In other embodiments, an additional “A” layer or “B” layer may be added to the A/B unit to form still other units. Such embodiments may have the A/B/A layer arrangement as shown in FIG. 3, or the B/A/B layer arrangement shown in FIG. 4 (for example, to create five layer structures). In still other embodiments, any of the above, or other, units may be stacked in order to form various repeating units. Some examples of other possible layer arrangements are described in greater detail below.

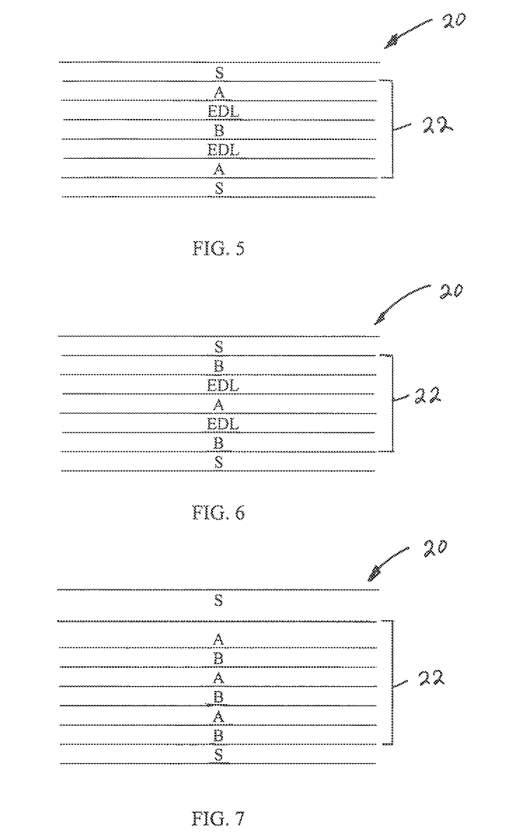

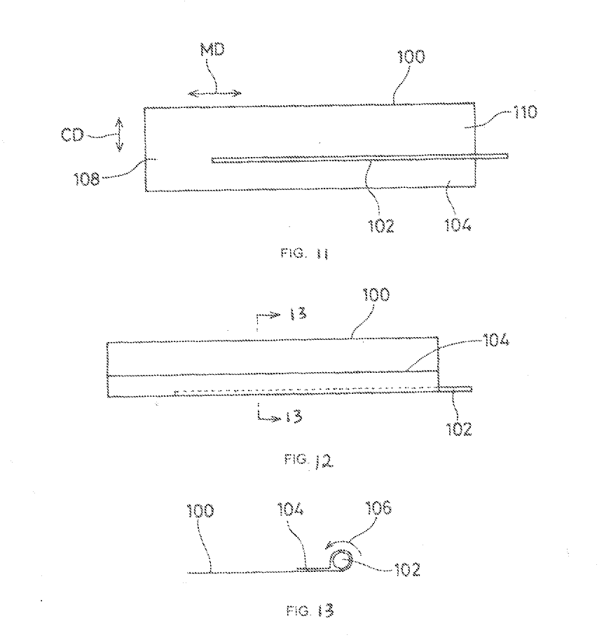

As shown in FIGS. 5 and 6, in certain embodiments, the multi-layer film 20 may comprise a seven layer structure. FIG. 5 shows a seven layer multi-layer film comprising an S/A/EDL/B/EDL/A/S layer arrangement. FIG. 6 shows a seven layer multi-layer film 20 comprising an S/B/EDL/A/EDL/B/S layer arrangement. The films containing such EDL's may have improved mechanical properties such as higher resistance to dart drop. In other embodiments, the A/EDL/B/EDL/A stack (or the B/EDL/A/EDL/B stack) may be part of a multi-layer repeating stack. Multi-layer repeating stacks may be designated by reference letter M. One example of such a structure is shown in FIG. 10.

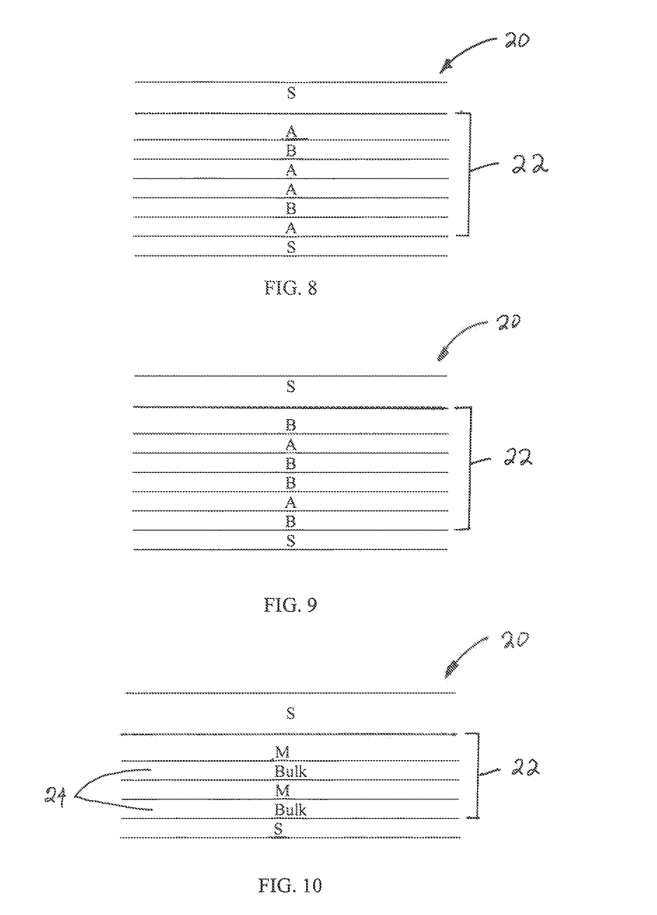

The various layer arrangements, thus, may include, but are not limited to any of the following multi-layer or microlayer stacks surrounded by skin layers: S/(A/B)ₙ/S (such as shown in FIG. 7); S/(A/C/B)ₙ/S; S/(A/B/A)ₙ/S (such as shown in FIG. 8); S/(B/A/B)ₙ/S (such as shown in FIG. 9); S/(A/C/B/C/A)ₙ/S; S/(A/B/A/C/A/B/A)ₙ/S; S/(A/C/D/B/D/C/A)ₙ/S; or S/(A/B)ₙ/C/(B/A)ₙ/S layers, where ‘n’ is the number of adjacent identical layer stacks. The film may comprise a single unit of the designated layers when “n” is equal to 1. Alternatively, the layers may be in a repeating, sequentially alternating arrangement where “n” is greater than or equal to 2.

The multi-layer or microlayer stacks, M, can be disposed in numerous arrangements, including but not limited to: throughout the entire film structure; through portions of the film thickness; or distributed in various groups within the film.

If the film comprises microlayers, the film may comprise more than one different microlayer sequence. For example, the film may comprise an additional microlayer sequence, comprised of repeating units where the number of repeating units can be equal to or different from n, and the structure of the microlayer sequence can be different from the structure of another microlayer sequence in any of the following features: number of microlayers; composition thereof; thickness; and relative thickness of the microlayers. When one or more additional microlayer sequences are present, they may be directly adhered one to the other. Alternatively, they may be separated by one or more layers serving different purposes, such as adhesive layers, used to increase the bond between the microlayer sequences, or bulk layers to increase the thickness of the overall structure.

The number of repeating units (stacks) in a repeating microlayer sequence is at least 2, alternatively at least 3, and alternatively at least 4. The number of repeating units can, however, be much higher than 3 or 4 (or even 5 or 6). The number of repeating units can, for example, comprise a multiple of 3, 4, 5, or 6. Typically, the number of repeating units is dictated by the particular technology used for the manufacture of these structures. The maximum number of layers in each repeating unit will depend on the extrusion equipment employed. Repeating units (stacks) comprising from two up to 9 or 10 layers, or more are possible. Non-limiting examples include repeating units (stacks) that are comprised of 5, 6, or 7 layers.

These structures are generally obtained using multiplier technology, where the multi-layer melt flow corresponding to the first unit which is coextruded may be split, for example, perpendicular to the coextrusion layer interface, into a number of packets, (e.g., two, three or four), each having the same number and sequence of layers corresponding to that of the first unit. The packets are then stacked one on top of the other, and recombined, to provide for a multiplied number of units in an alternating sequence. For example, a two layer coextruded unit that is split into three packets, stacked, and recombined results in a coextrusion with 6 parallel layers, such as three sets of A/B layers. In turn, these can still be split and recombined one or more times. The number of packets in which each melt flow can be split is not limited to two, three or four, such values that are given above only by way of example, and can easily be higher. In particular the multiplier technology currently available allows splitting a melt flow into two or four packets that are then stacked, one on top of the other, and processed as described above where each further splitting step can foresee an equal or a different number of packets. In principle, the number of multiplying steps can be as high as the equipment may allow and the resins may withstand. Typically, the number of multiplying steps is maintained between 1 and 6, alternatively between 2 and 5, alternatively between 2 and 4, and the number of layers in any microlayer sequences may comprise up to 1,000 microlayers, with a typical maximum of 800, 700, 600, 500, 400, 300, 200, or fewer microlayers.

Thus, while FIGS. 1-10 generally illustrate various layer arrangements for multi-layer polymeric films in a simplified manner, it will be appreciated that the multi-layer polymeric films described herein can comprise from about 4 layers to about 1,000 layers; alternatively from about 5 layers to about 200 layers; alternatively from about 5 to about 64 layers.

As in any coextrusion process, the polymers or polymer blends used in the microlayer sequence may be selected and combined in the respective layers in such a way to yield polymer streams with similar rheological properties during co-extrusion. That is, the polymer streams may be sufficiently similar in viscosity at the temperatures chosen for the co-extrusion process to avoid significant interfacial instability. It may be desirable for the ratio of polymer layer viscosities used in the microlayer sequence to have a range from 1:3 to 3:1. The viscosity can be measured at shear rates between 10 sec⁻¹ and 100 sec⁻¹. The viscosity can be modeled using the Cross equation in the shear rate range of interest.

The films described herein may, in some cases, be substantially or completely non-heat shrinkable. Thus, the films will typically not be reheated and stretched post-extrusion to orient or align the crystallites or molecules of the materials forming the film. “Substantially non-heat shrinkable” films will have a total free shrink of less than 10% at 200° F. (93° C.) under ASTM D2732-03. In some cases, the films will have a total free shrink of less than 5%, or less than 1% under such conditions. In other instances, the films may be rendered heat-shrinkable, and have a total free shrink greater than or equal to the amounts specified.

When, as described herein, there are differences between the composition of the adjacent layers, the multi-layer polymeric film may have improved properties relative to films having the same material composition blended into a single layer and/or in typical one to three layer films. Such properties may include, for example one or more of the following: greater molecular orientation; higher tensile strength, higher tensile yield strength; higher impact resistance; and better resistance to tear. However, it should be understood that such improved properties are not required to be present unless specified in the appended claims. The multi-layer films may be substantially transparent, or they can be opacified.

The multi-layer polymeric films described herein can have any suitable thickness including, but not limited to a thickness between: about 7 micrometers (about 0.007 mm or about 0.3 mil) and about 250 micrometers (about 10 mils); alternatively from about 10 micrometers (about 0.4 mils) or about 13 micrometers (about 0.5 mils) to less than about 100 micrometers (about 4 mils); alternatively from about 13 micrometers (about 0.5 mils) to less than about 50 micrometers (about 2 mils). In certain embodiments, the multi-layer films described herein may be down-gauged for use in similar applications by amounts greater than or equal to about 5%, 10%, 15%, 20%, 25%, 30%, or about 35% or more relative to conventional three layer polyolefin films where only LLDPE, HDPE or only a polypropylene core layer structure is used, while delivering comparable, or in some cases, improved mechanical properties. The multi-layer films described herein may, thus, be made relatively thin (for example, in cases in which the film is less than about 50 micrometers (about 2 mils) thick. Such thin films can provide increased flexibility that is desirable for the applications described herein.

In certain embodiments, the polymers described above can be made into a cast film having an average or bulk density from about 0.90 g/cm³ to about 0.95 g/cm³, alternatively from about 0.92 g/cm³ to about 0.94 g/cm³. The melt flow rate for resins used in such cast films can be from about 0.8 g/10 min to about 20 g/10 min, alternatively from about 1 g/10 min to about 10 g/10 min. The melt flow rate for the resins can be measured in accordance with ASTM D1238-10, respectively using the standard conditions for polyethylene, which are 190° C./2.16 kg, or the standard conditions for polypropylene, which are 230° C./2.16 kg. The polymers can also be formed as blown films and can have a melt flow rate ranging from about 0.4 g/10 min to about 8 g/10 min, alternatively from about 0.5 g/10 min to about 4 g/10 min.

The multi-layer polymeric films described herein can be utilized in a variety of alternative applications, including, but not limited to: personal care absorbent products such as diapers, training pants, incontinence garments, sanitary napkins, and other hygiene articles, bandages, wipes and the like, and other disposable products such as trash bags and food bags; as well as straws and covered containers for food handling, preparation, serving, storage, and/or transportation; and packaging materials. Suitable packaging materials include, but are not limited to: bags for consumer products (such as disposable absorbent articles and fabric care products), and pouches, and/or releasable wrappers for individual wrapping hygiene articles, such as sanitary napkins. For example, the multi-layer polymeric film may be useful as a liquid impervious backsheet and/or barrier cuff on a disposable absorbent article. The multi-layer polymer films can be joined with other films to form a laminate arrangement. Thus, the multi-layer polymeric film can serve as a hygiene film that can be joined with a nonwoven material to form a laminate structure that can be used in hygiene related applications.

### III. Methods of Making the Films

The present disclosure further relates to a method for making the multi-layer polymeric film. The aforementioned multi-layer polymeric films may be prepared by any suitable method. Multi-layer polymeric films can be made by known coextrusion processes, and are typically made using a flat cast or planar sheet or annular blown film process. For cast films, methods to make films can include employing a conventional high output, high speed cast coextrusion line using multiple extruders, as well as those that use more elaborate techniques such as a “tenter framing” process. The multi-layer films described herein can also be formed using conventional blown film coextrusion techniques. The processing conditions will depend upon the materials being used, the processing equipment and the desired film properties. Examples of early multi-layer processes and structures are shown in U.S. Pat. Nos. 3,565,985; 3,557,265; and 3,884,606.

Coextruded cast film or sheet structures typically have 2 to 5 layers; however, cast film or sheet structures including hundreds of layers are known. In one method for making a multi-layer film, the number of layers may be multiplied by the use of a device as described in U.S. Pat. No. 3,759,647. Other methods are further described in U.S. Pat. Nos. 5,094,788 and 6,413,595. Such methods involve forming a first stream comprising discrete, overlapping layers of the two or more materials which are divided substantially perpendicular to the coextrusion layer interface into a plurality of branch streams. These branch streams are redirected and repositioned into stacks of the branch streams, and are recombined in overlapping relationship with layer interface essentially perpendicular to the stacking direction to form a second stream having a greater number of discrete, overlapping layers of the one or more materials which are distributed in the prescribed gradient or other distribution. In certain embodiments, thin layers can be formed on spiral channel plates and these layers can flow into a central annular channel where micro-layer after micro-layer can then be stacked inside traditional thick layers. Such examples are described in U.S. Patent Publication No. US 2010/0072655 A1 (assigned to Cryovac, Inc.). PCT Publication WO 2008/008875 discloses a method of forming alternative types of multi-layered structures having many, for example fifty to several hundred, alternating layers of foam and film. Layer multiplication technology for cast films is marketed by companies such as Extrusion Dies Industries, Inc. of Chippewa Falls, Wis. and Cloeren Inc. of Orange, Tex.

Other manufacturing options include blown film (bubble) processes, as described, for example, in The Encyclopedia of Chemical Technology, Kirk-Othmer, Third Edition, John Wiley & Sons, New York, 1981, Vol. 16, pp. 416-417 and Vol. 18, pp. 191-192. Processes for manufacturing biaxially oriented film such as the “double bubble” process described in U.S. Pat. No. 3,456,044 (Pahlke), and other suitable processes for preparing biaxially stretched or oriented film are described in U.S. Pat. No. 4,865,902 (Golike et al.); U.S. Pat. No. 4,352,849 (Mueller); U.S. Pat. No. 4,820,557 (Warren); U.S. Pat. No. 4,927,708 (Herran et al.); U.S. Pat. No. 4,963,419 (Lustig et al.); and U.S. Pat. No. 4,952,451 (Mueller). Other multi-layer polymeric film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 1-80 (published by TAPPI Press (1992)).

A plurality of layers may be made in blown films by various methods. In U.S. Patent Publication No. US 2010/0072655 A1, two or more incoming streams are split and introduced in annular fashion into a channel with alternating microlayers that are surrounded by standard layer polymeric streams to form blown films containing microlayer regions. For annular dies, a known microlayer process for creating a plurality of alternating layers involves distributing the flow of the first polymer stream into every odd internal microlayer layer and distributing the flow of the second polymer stream into every even microlayer. This microlayer group is then introduced between channels of polymer streams of standard thickness. Microlayer and nanolayer technology for making blown films is marketed by BBS Corporation of Simpsonville, S.C.

Tenter orientation processes may also be used in the biaxial orientation of the multi-layer films described herein. In some cases, the film may be stretched from 50% to 300% in the machine direction, and from 100% to 500% in the transverse direction.

The multi-layer polymeric films can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, Jun. 15-17 (1981), pp. 211-229. If the film is a coextrusion of two or more layers (also described by Osborn and Jenkins), the film may still be laminated to additional layers of packaging materials, depending on the other physical requirements of the final film. “Laminations vs. Coextrusion” by D. Dumbleton (Converting Magazine (September 1992), also discusses lamination versus coextrusion. The multi-layer polymeric films described herein can also go through other post extrusion techniques, such as a biaxial orientation process or uniaxial orientation.

The films described herein may be subjected to a post-quench biaxial orientation process. As is well known in the art, orientation may be achieved by reheating an extruded, quenched and unoriented polymeric film in an oven or heated zone that raises the temperature of the polymeric material above its glass transition temperature. The material is then stretched in at least one direction to orient, or align, the polymer chains within the film. The film is then annealed and subsequently cooled thereby allowing crystals to reform so that the stretch and orientation is maintained. The multi-layer films may be stretched by 100% to 700% to create machine direction orientation if the cooled web is warmed prior to stretching. The stretch temperature selected is a compromise between maximizing the tensile strength of the film, line efficiency, and line speed.

In some cases, a double-bubble orientation process may be used. A blown film may be oriented using a double or triple bubble process. For instance, a double bubble process starts with a melt stream of a polymeric material, exiting the blown die. The extruded film is hot blown by conventional techniques to form a blown bubble. An air cooling ring positioned circumferentially around the blown bubble cools the thermoplastic melt as it exits the die. The initial bubble is melt oriented in both the machine and transverse directions. Various blow up ratios may be used, such as a blow up ratio of between 1.5 and 3.0. The initial bubble is collapsed into a tube at pinch rolls. The collapsed bubble is then reheated and re-inflated to form the bubble and further orient the film in a blown bubble process. Re-inflation is done in a conventional manner by trapping air or other hot gas within the film tube so that the material stretches at its orientation temperature. The re-inflated and enlarged bubble is collapsed at a second set of pinch rolls. More re-inflation steps may be used such as in a triple bubble to relax the film and reduce the shrinkage to near zero.

### EXAMPLES

Several multi-layer films are created having 3, 5, 7, and 34 total layers with the outer two layers being skin layers and the interior layers being core layers and/or EDL layers. The materials used in the films are contained in Table 1. The formula and structure for the blown film examples are outlined in Table 2. The physical properties for Comparative Exs. 1 and 2, and Exs. 1 and 2 are shown in Table 3. The physical properties for Exs. 3-5 are shown in Table 4. An illustration of the 5 and 7 layer film examples can be found in FIG. 4 and FIG. 6, respectively. The blown film processing parameters are common to those skilled in the art and can be found in the book entitled “Blown Film Extrusion: An Introduction” by Kirk Cantor, published by Carl Hanser Verlag; Munich, Germany, 2006. Typical temperatures used in making cast films are 220 to 260° C. melt temperature, and temperatures used in making blown films are 210 to 240° C.

Tables 2 and 3 show two examples of the multi-layer film in a 5 and 7 layer film structure (Examples 1 and 2, respectively) which yield comparable properties to three layer commercially available films (Comparative Exs. 1 and 2) that have higher caliper. These examples deliver 23-28% down-gauging potential compared to the commercially available films.

Table 4 shows the benefits of adding polyolefin plastomer (POP) to the film. Example 3 has no POP. Example 4 is a similar layer structure but has POP added to the “A” Layer. Example 5 is similar in structure to the film in Ex. 3, but has two EDL layers comprised of POP added in between the “A” and “B” Layers. Table 4 shows that the MD Elmendorf tear and dart impact energy values substantially increase without negatively impacting the other properties, when POP is utilized as a blend in the “A” layer or in separate EDLs.

The formula and structure for the cast film examples are outlined in Table 5 and the physical properties are shown in Table 6. The three films shown in Table 5 have essentially identical overall formulations but different layering structures. Each of the films has two outer skin layers and the remaining layers are interior core layers. The three layer example (Comparative Ex. 3) has equivalent amounts of HDPE, coPP, and LLDPE in the core section as the other two examples but it only has one core layer. Thus, the core layer is a blend. The 5 and 34 layer examples, Examples 6 and 7, respectively, have distinct and separate “A” and “B” layers in the core. The film in Example 6 is illustrated in FIG. 4. The 34 layer film in Example 7 has repeating B/A units with B layers forming the outside of the core of the film.

The resulting films exhibit good mechanical strength in both the machine direction and cross-machine direction of the film as shown in Table 6. The properties tested are comparable or higher in the 5 and 34 layer examples (Examples 6, 7) compared to the three layer example (Comparative Ex. 3). (Note: 1 mil is equal to 0.001 inch, or 0.025 mm.) These examples demonstrate the benefits of separating the HDPE and PP layers and utilizing a multi-layer film structure to improve mechanical properties.

TABLE 1
Materials used in Film Making

| Resin | Blown Films | Cast Films |
|---|---|---|
| LLDPE | DOWLEX ® 2045G | DOWFEX ® 2047G |
| LDPE | n/a | ExxonMobil LD 117.85 |
| POP | Dow AFFINITY ® | n/a |
| | 1850G | |
| HDPE | LBI M6210 | LBI M6020 |
| coPP | LBI PROFAX ® 7624 | LBI PROFAX ® 7624 |

Note:
The concentrations of additives in the skin layers are as follows: 1.25% Ampacet 10090 slip agent, 0.05% Ampacet 102741 antioxidant, and 1.25% Ampacet 101736 antiblock, all obtained from Ampacet Corporation, Tarrytown, NY, U.S.A.

TABLE 2
Formula, Structure, and Key Processing Parameters for Blown Films

| | | | | | coPP | POP | HDPE | |
|---|---|---|---|---|---|---|---|---|
| | | | Basis | Calculated | conc. | conc. | conc. | wt. % |
| | | # | Wt | Caliper | in “A” | in “A” | in “B” | A |
| Sample | Description | Layers | (gsm) | (mil) | Layer | Layer | Layer | Layer |
| Comparative | 3 Layer Polyethylene | 3 | 38.1 | 1.60 | n/a | n/a | n/a | n/a |
| Ex. 1 | Commercial Blown Film | | | | | | | |
| Comparative | 3 Layer Polyethylene | 3 | 35.5 | 1.50 | n/a | n/a | n/a | n/a |
| Ex. 2 | Commercial Blown Film | | | | | | | |
| Ex. 1 | 5 layers (S/B/A/B/S) | 5 | 27.3 | 1.16 | 70% | 0% | 100% | 20.0% |
| Ex. 2 | 7 layers (S/B/C/A/C/B/S) | 7 | 27.1 | 1.15 | 70% | 0% | 100% | 20.0% |
| Ex. 3 | 5 layers (S/B/A/B/S) | 5 | 27.9 | 1.19 | 70% | 0% | 100% | 35.0% |
| Ex. 4 | Ex. 3 (S/B/A/B/S) with 30% | 5 | 27.5 | 1.17 | 70% | 30% | 100% | 35.0% |
| | POP in coPP (“A”) layer | | | | | | | |
| Ex. 5 | Ex. 3 with two EDL layers | 7 | 27.2 | 1.16 | 70% | 0% | 100% | 35.0% |
| | added 7 layers | | | | | | | |
| | (S/B/C/A/C/B/S) | | | | | | | |

| | | wt. % | | | | | Frost | |
|---|---|---|---|---|---|---|---|---|
| | wt. % | C | wt. % | Blow- | Take- | | Line | Draw- |
| | B | (POP) | Skin | up | up | Forming | Height | down |
| Sample | layer | Layer | Layer | Ratio | Ratio | Ratio | (cm) | Ratio |
| Comparative | n/a | n/a | n/a | no | no | no | no | no |
| Ex. 1 | | | | data | data | data | data | data |
| Comparative | n/a | n/a | n/a | no | no | no | no | no |
| Ex. 2 | | | | data | data | data | data | data |
| Ex. 1 | 20.0% | 0% | 60.0% | 2.3 | 23.5 | 10.2 | 82 | 29.6 |
| Ex. 2 | 20.0% | 8% | 52.0% | 2.3 | 23.5 | 10.2 | 74 | 29.6 |
| Ex. 3 | 20.0% | 0% | 45.0% | 2.3 | 23.6 | 10.2 | 80 | 29.6 |
| Ex. 4 | 20.0% | 0% | 45.0% | 2.3 | 23.6 | 10.2 | 86 | 29.6 |
| Ex. 5 | 20.0% | 8% | 37.0% | 2.3 | 24.3 | 10.5 | 74 | 29.7 |

*The balance of the resin in the “A” layers is LLDPE. The skin layers are comprised of LLDPE and additives.

TABLE 3
Physical Properties of First Group of Films Described in Table 2

| | | | | | CD | | | | Web | | |
|---|---|---|---|---|---|---|---|---|---|---|---|
| | | | Basis | Calculated | Tensile | CD % | MD Tensile | MD % | Modulus | MD | |
| | | # | Wt | Caliper | At Peak | Strain | At Peak | Strain | at 1% | Elmendorf | Dart Impact |
| Sample | Description | Layers | (gsm) | (mil) | (N/cm) | At Peak | (N/cm) | At Peak | (N/cm) | Tear (g) | Energy (J) |
| Comparative | 3 Layer Polyethylene | 3 | 38.1 | 1.60 | 9.7 | 669 | 10.9 | 271 | 110 | 365 | 1.3 |
| Ex. 1 | Commercial Blown Film | | | | | | | | | | |
| Comparative | 3 Layer Polyethylene | 3 | 35.5 | 1.50 | 16.1 | 377 | 15.4 | 380 | 82 | 37 | 1.2 |
| Ex. 2 | Commercial Blown Film | | | | | | | | | | |
| Ex. 1 | 5 layers (S/B/A/B/S) | 5 | 27.3 | 1.16 | 9.9 | 678 | 13.6 | 562 | 133 | 115 | 1.3 |
| Ex. 2 | 7 layers (S/B/C/A/C/B/S) | 7 | 27.1 | 1.15 | 9.9 | 687 | 13.2 | 561 | 128 | 104 | 1.5 |

TABLE 4
Physical Properties of Second Group of Films Described in Table 2

| | | | | | CD | | | | Web | | |
|---|---|---|---|---|---|---|---|---|---|---|---|
| | | | Basis | Calculated | Tensile | CD % | MD Tensile | MD % | Modulus | MD | |
| | | # | Wt | Caliper | At Peak | Strain | At Peak | Strain | at 1% | Elmendorf | Dart Impact |
| Sample | Description | Layers | (gsm) | (mil) | (N/cm) | At Peak | (N/cm) | At Peak | (N/cm) | Tear (g) | Energy (J) |
| Ex. 3 | 5 layers (S/B/A/B/S) | 5 | 27.9 | 1.19 | 10.8 | 704 | 14.7 | 560 | 150 | 61 | 0.7 |
| Ex. 4 | Ex. 3 (S/B/A/B/S) with 30% | 5 | 27.5 | 1.17 | 10.6 | 692 | 14.5 | 559 | 139 | 73 | 1.1 |
| | POP in coPP (“A”) layer | | | | | | | | | | |
| Ex. 5 | Ex. 3 with two EDL layers | 7 | 27.2 | 1.16 | 9.7 | 677 | 13.2 | 565 | 144 | 90 | 1.3 |
| | added - 7 layers | | | | | | | | | | |
| | (S/B/EDL/A/EDL/B/S) | | | | | | | | | | |

TABLE 5
Formula and Structure of Cast Films

| | | | Mass | | | | | |
|---|---|---|---|---|---|---|---|---|
| | | | Flow | Draw | coPP | HDPE | | POP |
| | | # | Rate | Speed | conc. in | conc in | wt. % A | conc in |
| Sample | Description | Layers | (kg/hr) | (m/min) | A | B | Layer | A |
| Comparative | base formulation, 3 | 3 | 2.3 | 3.7 | n/a | n/a | n/a | n/a |
| Ex. 3 | layers, cast | | | | | | | |
| ex. 6 | base formulation, 5 | 5 | 2.1 | 4.1 | 70%* | 80%* | 25.0% | 0% |
| | layers ((S/B/A/B/S)), | | | | | | | |
| | cast | | | | | | | |
| ex. 7 | base formulation, 34 | 34 | 1.9 | 3.7 | 70%* | 80%* | 25.0% | 0% |
| | layers | | | | | | | |
| | (S/B/A/B/A/B . . . A/B/S), | | | | | | | |
| | cast | | | | | | | |

| | | wt. % C | wt. % | | | | | |
|---|---|---|---|---|---|---|---|---|
| | wt. % B | (POP) | Skin | Total | Total | Total | Total | |
| Sample | layer | Layer | Layer | LLDPE | LDPE | coPP | HDPE | Additive |
| Comparative | n/a | n/a | 50.0% | 52.1% | 9.4% | 20.0% | 17.5% | 1.0% |
| Ex. 3 | | | | | | | | |
| ex. 6 | 25.0% | 0% | 50.0% | 50.9% | 11.3% | 19.6% | 17.9% | 0.3% |
| ex. 7 | 25.0% | 0% | 50.0% | 50.9% | 11.3% | 19.6% | 17.9% | 0.3% |

*The balance of the resin in the “A” and “B” layers is LLDPE, and the skin layers are comprised of a blend of LLDPE/LDPE (85/15) and additives. The die gap is set at 0.5 mm for all cast film samples.

TABLE 6
Physical Properties of Films Described in Table 5

| | | | | | CD | | | | | MD | |
|---|---|---|---|---|---|---|---|---|---|---|---|
| | | | Basis | Calculated | Tensile | CD % | MD Tensile | MD % | Modulus | Elmendorf | Dart Impact |
| | | # | Wt | Caliper | At Peak | Strain | At Peak | Strain | at 1% | Tear | Energy |
| Sample | Description | Layers | (gsm) | (mil) | (MPa) | At Peak | (MPa) | At Peak | (MPa) | (g/micron) | (mJ/micron) |
| Comparative | base formulation, 3 | 3 | 28.8 | 1.23 | 31.3 | 720 | 39.8 | 608 | 409 | 1.9 | 12.8 |
| Ex. 3 | layers, cast | | | | | | | | | | |
| Ex. 6 | base formulation, 5 | 5 | 24.1 | 1.03 | 35.9 | 685 | 48.8 | 621 | 461 | 2.2 | 26.8 |
| | layers, cast | | | | | | | | | | |
| Ex. 7 | base formulation, 34 | 34 | 25.8 | 1.10 | 39.0 | 736 | 51.4 | 733 | 418 | 2.5 | 32.6 |
| | layers, cast | | | | | | | | | | |

### Test Methods

Key mechanical properties of the film (e.g., tensile strength and tear resistance) are measured using the following known analytical techniques.

Tensile tests are conducted using ASTM method D882. The samples are cut to 1 inch (2.54 cm) wide, the gauge length is 2 inches (5 cm), and the cross-head speed is set to 20 inches/min (50.8 cm/min). Line grips are used to hold the samples as described in ASTM D882 in section 3.1.1 and the air pressure is set to 550 kPa (80 psi).

Elmendorf tear tests are conducted using ASTM D1922.

Dart impact energy tests are conducted using ASTM D4272 with dart and weight specifications as described in sections 6.2.7 and 6.2.8 of the method. The mass of the dart used for this testing is 451 g.

Method to Measure Web Modulus and Material Modulus

Web modulus and material modulus of a test web are measured as follows.

1. Measurement of Tensile Stress of Web

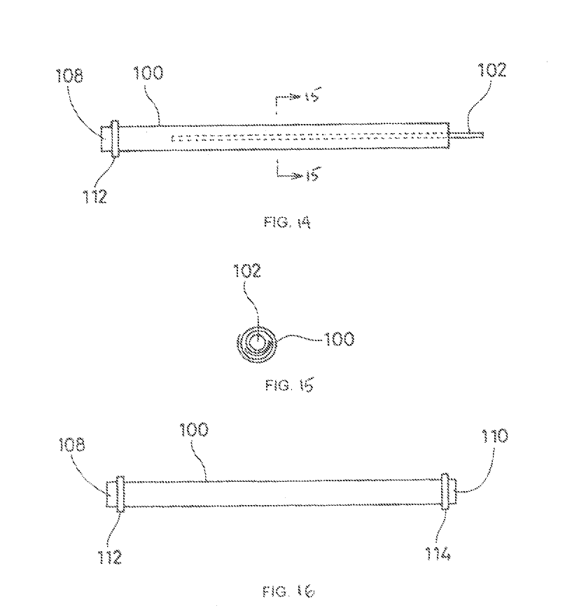

Sample Preparation
1. Cut a test web into a test piece 100 of 610 mm length in the machine direction (MD) and 200 mm width, place the test piece on a flat table, and smooth out any wrinkles to create a flat film. (FIG. 11).
2. Place the 9.5 mm diameter steel rod 102 on the test piece 100 in the MD such that its location in the cross direction (CD) should be in about ⅓ the way (about 67 mm) from one longitudinal side 104 of the test piece 100. The rod 102 should stick out of the test piece with about 2.5 cm so that it would be easier to remove it later. (FIG. 11).
3. Fold the side of one longitudinal side 104 of the test piece 100 over the rod 102 along the rod 102 and lay flat (FIG. 12). And then, tuck the test piece 100 around the rod 102 in the CD as shown by the arrow 106 (FIG. 13) and roll up the test piece 100. (FIGS. 14 and 15).
4. Be as careful as possible to avoid wrinkles in the test piece 100 and keep the rod parallel to the longitudinal side of the test piece 100. Flatten the first end edge 108 of the rolled test piece 100 in which the rod 102 is not present. Staple the flattened first end edge 108 several times (staple at the first end edge 108 is designated by the reference number of 112 in FIG. 14) through the multiple layers of the test piece 100 to join these layers so that they will not slip in during the test.
5. Pull the rod out of the second end edge 110 carefully not to let the test piece unwind. Flatten the second end edge 110 such that it is flat in the same plane as the first end edge 108, and staple it several times (staple at the second end edge 110 is designated by the reference number of 114 in FIG. 16) such that the distance between the staples at the first end edge 108 and the second end edge 110 is about 560 mm which is sufficient for the gauge length (508 mm) of the tensile tester below. Thus, a test sample is prepared.

Instrument Set Up
The instrument (Tensile tester: MTS SYNERGIE 400/MTS, TESTWORKS™ ver.3.06) is set up to pull the test samples under the following conditions.

| | |
|---|---|
| Master method | Tensile |
| Load Cell | 100 N |
| Gauge length | 508 mm |
| Cross head speed | 254 mm/minute |
| Points for reading stress | 0.5% strain increments up to 5% |
| Grip type | Line grips |
| Grip air pressure | 550 kPa |

Measurement

The measurement is made according to the following procedure.
1. Insert one end edge of a test sample into the upper jaw of tensile tester and close it.
2. Align the strip between the upper and lower jaws.
3. Place the other end edge of the test sample into the lower jaw with enough tension to eliminate any slack.
4. Reset the tension of the cross head (Load meter) of the tensile tester.
5. Close the lower jaw and confirm that the force on the load cell does not exceed more than 200% of the weight of the specimen.
6. Start tester.
From the measurement above, tensile stresses of the test sample are measured at 0.5% increments up to 5%.

2. Calculation of Film Basis Weight
1. Use ASTM D4321-09 to calculate the measured yield using the formula in section 8.1. Yield is reported in units of area/mass.
2. Basis weight is determined by taking the inverse of the yield (1/yield) and is reported in units of mass/area.

3. Calculation of Film Caliper
1. Film caliper is calculated by dividing the basis weight by bulk density and is reported in units of length.
2. Bulk density (mass/volume) is calculated as follows:

Bulk density=xₐρₐ+x_{b}ρ_{b} . . . +x_{z}ρₚ
where x is the mass fraction of each component (e.g. a, b, . . . , z) in the film and ρ is the density of each component as published by the resin manufacturer.

4. Calculation of Web Modulus
Web modulus is determined by calculating the slope of the stress-strain curve using a linear regression on the points between +/−0.5% of the given strain and dividing by the relaxed web width measured before the test. The program is set to report web modulus at 1%, 2%, and 3%. For example, web modulus at 2% is calculated as follows:

$$\begin{matrix}Slope @ 2 \% strain = \frac{{y}_{2} - {y}_{1}}{{x}_{2} - {x}_{1}} \\ = \frac{force at 2.5 \% strain - force at 1.5 \% strain}{2.5 \% strain - 1.5 \% strain}\end{matrix}$$

where the units are N/% strain. Web modulus is calculated from the slope as follows:

$$\begin{matrix}Web modulus @ 2 \% strain = \frac{Slope @ 2 \% strain ( \frac{N}{\% strain} )}{Web width before test ( cm )} \\ = \frac{N}{\% strain} \times \frac{100 \% strain}{web width ( cm )}\end{matrix}$$

where the units are N/cm.

5. Calculation of Material Modulus
Web modulus is measured with the test method above. Material modulus is calculated by dividing the web modulus by the material caliper as follows:

$$Material modulus @ 2 \% ( MPa ) = \frac{Web modulus @ 2 \% ( \frac{N}{cm} )}{Material caliper ( cm )} \times \frac{1 \times {10}^{4} {cm}^{2}}{1 {m}^{2}} \times \frac{1 MPa}{1 \times {10}^{6} Pa}$$

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” In addition, whenever a limit or range is stated as being “greater than” or “less than”, the range may be expanded to include amounts equal to the stated limit or range. Similarly, whenever a limit or range is stated as being “greater than or equal to” or “less than or equal to”, the limit or range may be reduced to exclude amounts equal to the stated limit or range.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-layer polymeric film having two outer surfaces and a thickness, said film comprising:
a combination of layers forming the core of said film, said combination of layers comprising:
a) at least one polypropylene-rich “A” layer having a thickness, wherein polypropylene is the major component of the “A” layer, wherein the thickness of the “A” layer(s) comprises from about 10% to about 30% of the thickness of the multi-layer polymeric film; and
b) at least one polyethylene-rich “B” layer having a thickness, comprising high density polyethylene (HDPE) as the major component, wherein said “B” layer is joined at least indirectly to said “A” layer, wherein the thickness of the “B” layer(s) comprises from about 10% to about 30% of the thickness of the multi-layer polymeric film,
wherein each “A” layer and each “B” layer has a thickness of greater than or equal to about 0.05 micrometers to less than or equal to about 15 micrometers; and
a pair of polymeric skin layers, one skin layer forming each of the outer surfaces of said multi-layer polymeric film, wherein the skin layers have a combined thickness that is between about 40% to about 80% of the film thickness, and said combination of layers forming the core of the film is at least indirectly joined to said skin layers.

2. The multi-layer polymeric film of claim 1, wherein at least some of said polypropylene in said “A” layer comprises homo-polymer PP.

3. The multi-layer polymeric film of claim 1, wherein at least some of said polypropylene in the “A” layer comprises coPP.

4. The multi-layer polymeric film of claim 1, wherein at least some of said polypropylene in the “A” layer comprises impact copolymer polypropylene (ICP).

5. The multi-layer polymeric film of claim 1, wherein the “A” layer comprises a blend of polypropylene and at least one of LDPE, LLDPE, polyolefin plastomer (POP), polyolefin elastomer (POE), and olefin block copolymer (OBC).

6. The multi-layer polymeric film of claim 1, wherein the HDPE in the “B” layer has a density greater than or equal to 0.95 g/cm³.

7. The multi-layer polymeric film of claim 3, wherein the HDPE in the “B” layer has a density greater than or equal to 0.95 g/cm³.

8. The multi-layer polymeric film of claim 1, wherein the “B” layer comprises a blend of said HDPE and at least one ethylene alpha-olefin.

9. The multi-layer polymeric film of claim 1, wherein the “B” layer comprises a blend of said HDPE and at least one of: polyolefin plastomer (POP), polyolefin elastomer (POE), and OBC.

10. The multi-layer polymeric film of claim 1, wherein the “B” layer comprises a blend of said HDPE and at least one of: LDPE, LLDPE, ethylene vinyl acetate, and ethylene methyl acrylate.

11. The multi-layer polymeric film of claim 1, wherein at least one of said skin layers comprises a blend of LDPE and LLDPE.

12. The multi-layer polymeric film of claim 1, further comprising at least one of the following additional layers:
an additional “A” layer so that there is more than one “A” layer;
an additional “B” layer, so that there is more than one “B” layer,
wherein the at least one additional layer is positioned within the core of the film.

13. The multi-layer polymeric film of claim 1, further comprising a “C” layer that has a different composition from the “A” and “B” layers, wherein said “C” layer is positioned within the core of the film, and said “C” layer is a bulk layer having a thickness less than 10% of the film thickness.

14. The multi-layer polymeric film of claim 1, wherein at least one of said “A” layer, “B” layer, and skin layer comprises post consumer recycled polyolefins.

15. The multi-layer polymeric film of claim 1, wherein the film comprises a bio-based content of about 10% to about 100% using ASTM D6866-10, method B.

16. The multi-layer polymeric film of claim 12 wherein said combination of layers forming the core of the film comprises “A” and “B” layers in an alternating and adjacent configuration.

17. The multi-layer polymeric film of claim 16 wherein said combination of layers forming the core of the film comprises an additional “B” layer wherein at least a portion of said combination is in a B/A/B configuration.

18. The multi-layer polymeric film of claim 1 having a thickness between about 13 micrometers and about 50 micrometers.

19. A blown multi-layer polymeric film according to claim 1.

20. A cast multi-layer polymeric film according to claim 1.
